(19) United States
(12) Patent Application Publication
(10) Pub. No.: US 2026/0247502 A1
(43) Pub. Date: Aug. 20, 2026

(54) INDUCTION COOKING APPLIANCE AND METHOD

(71) Applicant: WHIRLPOOL CORPORATION, BENTON HARBOR, MI (US)

(72) Inventors: SALVATORE BALDO, VARESE (IT); MARIO BARBATI, VARESE (IT); ANDREA GALLIVANONI, VARESE (IT); PAOLO SANFELICE, VARESE (IT)

(21) Appl. No.: 19/057,057

(22) Filed: Feb. 19, 2025

(51) Int. Cl. H05B 6/06; H05B 6/12

(52) U.S. Cl. CPC H05B 6/062; H05B 6/1209; H05B 2213/07

(57) ABSTRACT

A method of controlling an induction cooking appliance having a cook surface and an induction coil electrically connected with a power supply, and with a cooking vessel disposed on the cook surface, the method comprising: obtaining a target power level for a cooking cycle; obtaining an initial power-frequency curve including a plurality of power levels at a plurality of frequencies; and alternating between operating the power supply in a first mode and a second mode to iteratively update the plurality of power levels and obtain an updated power-frequency curve; wherein operating the power supply in the first mode includes operating the power supply to adjust a power output of the induction coil toward the target power level; and operating the power supply in the second mode includes operating the power supply to update at least one power level of the plurality of power levels.

### TECHNICAL FIELD

The description generally relates to induction cooking appliances, and more specifically a controllable induction cooking appliance with a temperature module.

### BACKGROUND

Cooking appliances, such as cooktops, ranges, etc., have cook surfaces that generate heat for cooking or warming food items in a cooking vessel. Traditional cooking appliances provide thermal energy to the cook surface, such as by a gas fuel or electricity, which is conductively transferred to a cooking vessel placed thereon. In other examples, induction cooking appliances provide energy directly to the cooking vessel by way of electromagnetic induction using a variable-current coil and a suitable metallic cooking vessel. During operation, such induction cooking appliances can have much cooler surface temperatures compared to traditional cooking appliances with conductive burners.

### BRIEF SUMMARY

In an aspect, the disclosure relates to a method of controlling an induction cooking appliance having a cook surface and an induction coil electrically connected with a power supply, and with a cooking vessel disposed on the cook surface, the method comprising: obtaining a target power level for a cooking cycle; obtaining an initial power-frequency curve including a plurality of power levels at a plurality of frequencies; and alternating between operating the power supply in a first mode and a second mode to iteratively update the plurality of power levels and obtain an updated power-frequency curve; wherein operating the power supply in the first mode includes operating the power supply to adjust a power output of the induction coil toward the target power level; and operating the power supply in the second mode includes operating the power supply to update at least one power level of the plurality of power levels.

In an aspect, the disclosure relates to an induction cooking appliance comprising: a cook surface; an induction coil disposed adjacent the cook surface; a power supply electrically connected to the induction coil; and a controller electrically connected to the power supply, the controller configured to: control operation of the power supply to provide power from the power supply to the induction coil; obtain an initial power-frequency curve; and alternately operate the power supply in a first mode and a second mode to iteratively update a plurality of power levels of the initial power-frequency curve and obtain an updated power-frequency curve.

### BRIEF DESCRIPTION OF THE DRAWINGS

In the drawings:

FIG. 1 is a perspective schematic view of an induction cooking system in accordance with various aspects described herein.

FIG. 2 is a schematic cross-sectional view of an induction cooking system in accordance with various aspects described herein.

FIG. 3 is a schematic cross-sectional view of the induction cooking system illustrating heat transfer during operation in accordance with various aspects described herein.

FIG. 4 is a graph of effective heating power relative to operating frequency for an induction cooking system in accordance with various aspects described herein.

FIG. 5 is a flow diagram illustrating a method of operating an induction cooking system in accordance with various aspects described herein.

### DETAILED DESCRIPTION

Cooking appliances can include one or more sensors and one or more controllers for automatic control of a cycle of operation. For instance, in traditional cooking appliances with a hob utilizing gas or electric heat, a user may select a particular heat setting for the hob, e.g., “medium,” “power level 8,” or the like, for cooking a food item for a predetermined amount of time. However, a particular heat setting or power setting for a hob may not be the same as a cooking vessel temperature, or of a temperature of a cooking cavity within the cooking vessel, due to waste heat, user-interface specificity (e.g., knob sensitivity), or other effects. Inaccuracies of cooking vessel temperatures can lead to undesirable outcomes such as unpredictable cooking times or overcooking or undercooking of food items.

Induction cooking appliances can include controller modules providing estimates of component temperatures, such as pan temperatures, which may be difficult to directly sense or measure during use. However, such induction cooking appliances are typically calibrated for use with a limited set of cooking vessels and may not provide an accurate temperature estimate in the event that a different cooking vessel outside the calibrated set is used with the cooking appliance.

Aspects of the disclosure provide for an induction cooking appliance and control method used for compensating for changes, such as temperature changes, in controlling power delivery to an induction coil. The induction cooking appliance and control method described herein can be used with a wide range of cooking vessels, including cooking vessels that have not previously been used, tested, or the like with the disclosed induction cooking appliance.

Features, advantages, and aspects of the present disclosure are set forth or apparent from a consideration of the following detailed description, drawings, and claims. Moreover, the following detailed description is exemplary and intended to provide explanation without limiting the scope of the disclosure as claimed.

As used herein, the terms “first,” “second,” or the like can be used interchangeably to distinguish one component from another and are not intended to signify location or importance of the individual components. In addition, the singular forms “a,” “an,” and “the” include plural references unless the context clearly dictates otherwise.

Also, as used herein, while sensors can be described as “sensing” or “measuring” a respective value, sensing or measuring can include determining a value indicative of or related to the respective value, rather than directly sensing or measuring the value itself. The sensed or measured values can further be provided to additional components. For instance, the value can be provided to a controller module or processor, and the controller module or processor can perform processing on the value to determine a representative value or an electrical characteristic representative of said value.

Additionally, while terms such as “voltage”, “current”, and “power” can be used herein, it will be evident to one skilled in the art that these terms can be interrelated when describing aspects of the electrical circuit, or circuit operations.

Additionally, as used herein, a “controller” can include a component configured or adapted to provide instruction, control, operation, or any form of communication for operable components to effect the operation thereof. A controller can include any known processor, microcontroller, or logic device, including, but not limited to: field programmable gate arrays (FPGA), an application specific integrated circuit (ASIC), a proportional controller (P), a proportional integral controller (PI), a proportional derivative controller (PD), a proportional integral derivative controller (PID controller), a hardware-accelerated logic controller (e.g. for encoding, decoding, transcoding, etc.), or the like, or a combination thereof. Non-limiting examples of a controller can be configured or adapted to run, operate, or otherwise execute program code to effect operational or functional outcomes, including carrying out various methods, functionality, processing tasks, calculations, comparisons, sensing or measuring of values, or the like, to enable or achieve the technical operations or operations described herein. The operation or functional outcomes can be based on one or more inputs, stored data values, sensed or measured values, true or false indications, or the like. While “program code” is described, non-limiting examples of operable or executable instruction sets can include routines, programs, objects, components, data structures, algorithms, etc., that have the technical effect of performing particular tasks or implement particular abstract data types.

Such a controller as described herein may also compare a first value with a second value and may operate or control operations of additional components based on the satisfaction of that comparison. As used herein, the term “satisfies” or “satisfaction” of a comparison between a first value and a second value will refer to a determination of whether the first value exceeds the second value, or does not exceed the second value, or is equal to the second value, such that the comparison is “true” when satisfied. In addition, as used herein, the term “satisfies” or “satisfaction” of a comparison between a first value and a value range refers to a determination that the first value is within the value range, such that the comparison is “true” when satisfied. It will be understood that such a determination may easily be altered to be satisfied by a positive/negative comparison or a true/false comparison. Example comparisons can include comparing a sensed or measured value to a threshold value, or to a threshold value range. For example, when a sensed, measured, or provided value is compared with another value or range, including a stored or predetermined value or range, the satisfaction of that comparison can result in actions, functions, or operations controllable by the controller module.

Such a controller as described herein can further include a data storage component accessible by the processor, including memory, whether transient, non-transient, volatile, or non-volatile memory. Machine-executable instructions, associated data structures, and program modules represent examples of program code for executing methods disclosed herein. Machine-executable instructions can include, for example, instructions and data, which cause a general purpose computer, special purpose computer, or special purpose processing machine to perform a certain function or group of functions.

Additional non-limiting examples of the memory can include Random Access Memory (RAM), Read-Only Memory (ROM), flash memory, or one or more different types of portable electronic memory, such as discs, DVDs, CD-ROMs, flash drives, universal serial bus (USB) drives, the like, or any suitable combination of these types of memory. In one example, the program code can be stored within the memory in a machine-readable format accessible by the processor. Additionally, the memory can store various data, data types, sensed or measured data values, inputs, generated or processed data, or the like, accessible by the processor in providing instruction, control, or operation to effect a functional or operable outcome, as described herein.

Here and throughout the specification and claims, range limitations are combined and interchanged. Such ranges are identified and include all the sub-ranges contained therein unless context or language indicates otherwise. For example, all ranges disclosed herein are inclusive of the endpoints, and the endpoints are independently combinable with each other.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, secured, fastened, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

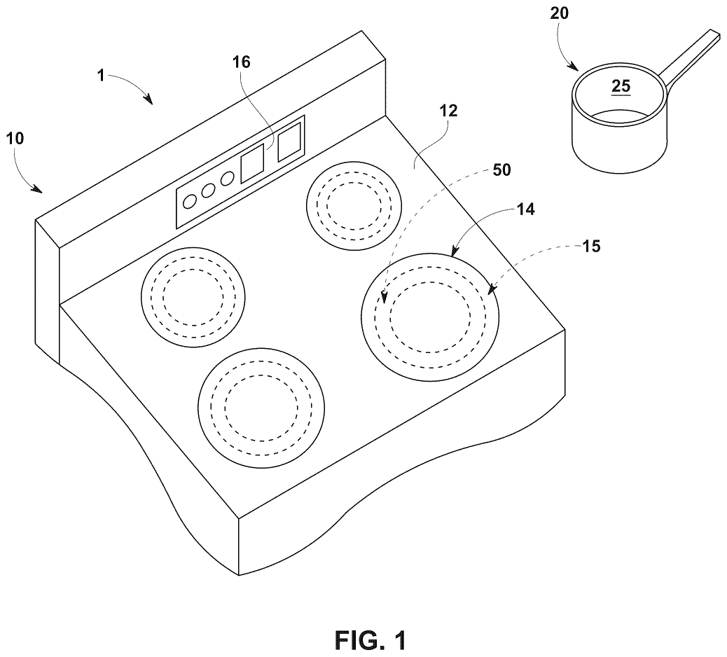

Turning to FIG. 1, an induction cooking system 1 can include a cooking appliance 10 (e.g., an induction cooking appliance) and a cooking vessel 20. The cooking appliance 10 can include a cook surface 12 that can define at least one heating zone 14 for heating the cooking vessel 20. The cooking appliance 10 can include a single heating zone 14 or multiple heating zones 14 accommodating multiple cooking vessels 20. The cooking vessel 20 can define a cooking cavity 25 for receiving food and/or beverage items. In the illustrated example the cooking vessel 20 is shown as a saucepan, however the cooking vessel 20 can have any suitable form such as a frying pan, a sheet pan, a bowl, a kettle, or others.

The cooking appliance 10 includes an induction heating system 50 that can be configured to generate heat within the cooking vessel 20 when positioned over the heating zone 14. The induction heating system 50 can include an induction coil 15 positioned beneath the cook surface 12. The cook surface 12 can include a material with a low electrical conductivity or a low thermal conductivity, such as glass or glass-ceramic in some examples. The cooking vessel 20 can include any suitable material for warming by electromagnetic induction, including ferromagnetic materials such as iron. The cooking vessel 20 can be directly heated via operation of the induction coil 15.

The cooking appliance 10 can further include a user interface 16. The user interface 16 can be used by a user to control operation of the cooking appliance 10, including setting a cooking mode, setting a cooking temperature or heat level, or setting a timer, in some examples. The user interface 16 can include any suitable interface elements such as buttons, knobs, toggles, display screens, touch screens, light sources, or audio sources, in some examples. As shown, the user interface 16 is located on the cooking appliance 10 though this need not be the case. In some implementations, the user interface 16 can be located on a separate device, such as a mobile device, a tablet, or a central hub in some non-limiting examples. It is also contemplated that the user interface 16 can include user-interactive elements on the cooking appliance 10 and additional user-interactive elements on a separate device.

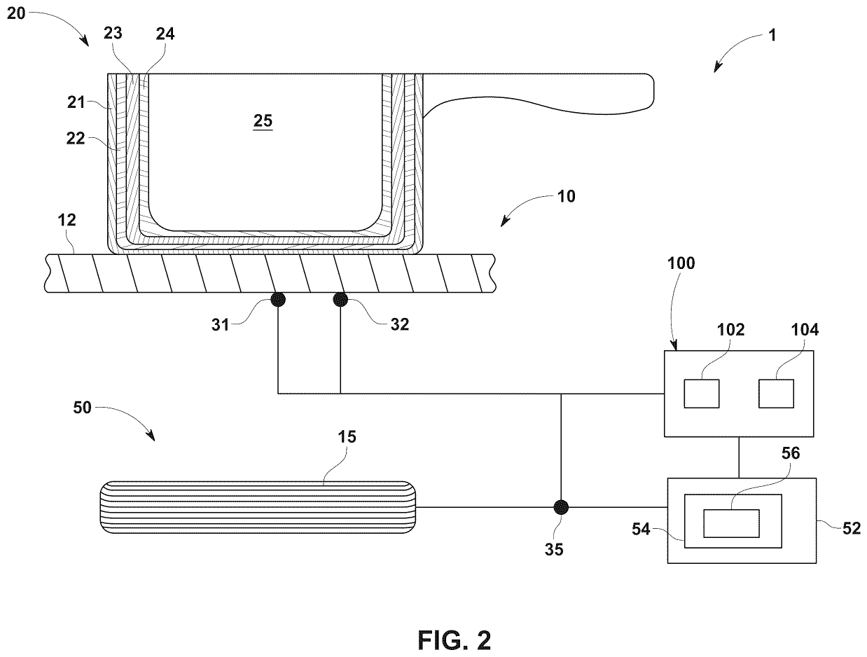

Turning to FIG. 2, a side cross-sectional view illustrates the cooking vessel 20 positioned on the cook surface 12. The induction coil 15 is schematically illustrated with wide spacing from the cook surface 12 for visual clarity, but the induction coil 15 can be positioned directly adjacent the cook surface 12 or with a small gap therebetween.

The cooking vessel 20 is illustrated as having multiple stacked material layers. The cooking vessel 20 can include any number of layers, including only one. For instance, in some implementations, the cooking vessel 20 can have a body formed with a single material or alloy throughout. In the exemplary implementation shown, the cooking vessel 20 includes a first layer 21, a second layer 22, a third layer 23, and a fourth layer 24. The first layer 21 defines a bottom of the cooking vessel 20 and can include a magnetic material such as magnetic steel. The second layer 22 can include aluminum, such as cast aluminum or hardened aluminum in some examples. The third layer 23 can include steel, such as magnetic steel or non-magnetic steel. The fourth layer 24 can include a non-stick material or coating, such as polytetrafluoroethylene (PTFE) or ceramic. In some implementations, the third layer 23 can be omitted and the cooking vessel 20 can be provided with a non-stick coating over the second layer 22. Any of the layers 21-24 can extend over predetermined portions of the cooking vessel 20. For instance, in some implementations, the first layer 21 can be provided or applied to the bottom of the cooking vessel 20 without extending up a sidewall. In this manner, the cooking vessel 20 may include a magnetic layer over a bottom portion only.

The induction heating system 50 can include a power supply 52 electrically coupled to the induction coil 15. The power supply 52 can provide power, including alternating-current (AC) power and/or direct-current (DC) power. In some implementations, other components such as power converters, inverters, transformers, or the like can be included with the power supply 52, such as to modify or adjust a power characteristic of the power output by the power supply 52. For example, the power supply 52 can include an inverter 54 configured to provide a power output (e.g., an AC power output) to the induction coil 15. The inverter 54 can, for example, include a resonant full-bridge configuration, a half-bridge configuration, or a quasi-resonant configuration, among others. The inverter 54 can include a set of switches 56 that can include one or more switches controllable to provide the power output. For example, the set of switches 56 can be controlled via one or more pulse width modulation (PWM) signals with various frequencies to provide the power output with corresponding power levels.

The cooking appliance 10 can include a controller 100. The controller 100 can, for example, operate the cooking appliance 10 via input from a user received at the user interface 16, such as for selecting a cycle of operation and controlling the operation of the cooking appliance 10 to implement the selected cycle of operation. The input from the user and/or the cycle can include and/or correspond to a target power level for the induction coil 15. The controller 100 can include machine-readable instructions for partially or fully automating operation of the cooking appliance 10 without direct control from the user. In some implementations, the controller 100 can be in signal communication with a local network and/or an external network, including by way of a wired connection and/or a wireless connection.

The controller 100 can be provided with at least a processor 102, such as a central processing unit (CPU), and a memory 104, for controlling and operating the cooking appliance 10. The memory 104 can be used for storing, for example, control software that is executed by the processor 102 in completing a cycle of operation using the cooking appliance 10. The memory 104 can also be used to store information, such as a database or table, and to store data received from the one or more components of the cooking appliance 10 that can be communicably coupled with the controller 100. The database or table can be used to store the various operating parameters for the cooking appliance 10, including factory default values for operating parameters and any adjustments to the factory default values by the control system or by user input. The memory 104 can store common settings, recipes, or other preferences common to the user, or other relevant information.

The controller 100 can be communicably and operably coupled with one or more components of the cooking appliance 10 for communicating with and/or controlling the operation of the component to complete a cycle of operation. Such a cycle of operation can include, but is not limited to, a cooking cycle, a baking cycle, a bread-proofing cycle, a defrost cycle, and/or a warming cycle. The controller 100 can be operably coupled to the power supply 52 for controlling the power output of the power supply 52 to the induction coil 15. For example, the controller 100 can provide the PWM signals to the power supply 52 to control operation of the set of switches 56, which can include adjusting the frequency of the PWM signals to adjust the power output of the power supply 52. The controller 100 can also be operably coupled with the user interface 16 for receiving user-selected inputs and communicating information to the user. For example, a user may select a temperature set point at which the user desires the temperature of the cooking vessel 20 to reach, or a cycle of operation which includes one or more temperature set points, which can include and/or correspond to the target power level for the induction coil 15.

The controller 100 can receive input from one or more sensors. In the implementation shown, the cooking appliance 10 includes a first temperature sensor 31 and a second temperature sensor 32, with the first temperature sensor 31 positioned centrally within the heating zone 14 and the second temperature sensor 32 positioned adjacent an edge of the heating zone 14. Other numbers and arrangements of temperature sensors can be utilized. The cooking appliance 10 can include a power sensor 35 configured to provide a signal indicative of electric power delivered to the induction coil 15. The electric power delivered to the induction coil 15 substantially corresponds to a thermal power delivered to the cooking vessel 20. For instance, the thermal power delivered to the cooking vessel 20 can be between 70-100% of the electric power delivered to the induction coil 15, including between 80-100% of the electric power, including between 90-100% of the electric power, including between 95-100% of the electric power. The power sensor 35 can be configured to sense or detect a current circulating through the induction coil 15 in some implementations, or to sense or detect the electrical power directly in some implementations. The circulating current correlates to the electrical power delivered to the induction coil 15 from the power supply 52. Furthermore, additional sensors can be provided for separate sensing or measuring of current within the induction coil 15, voltage across the induction coil 15, electrical power delivered to the induction coil 15, or combinations thereof, in non-limiting examples.

Sensor input from the first temperature sensor 31, the second temperature sensor 32, and/or the power sensor 35 can be used by the controller 100 to controllably operate the cooking appliance 10, such as setting or modifying a cooking time, the power supplied to the induction coil 15, and/or a temperature of the cooking vessel 20, in non-limiting examples.

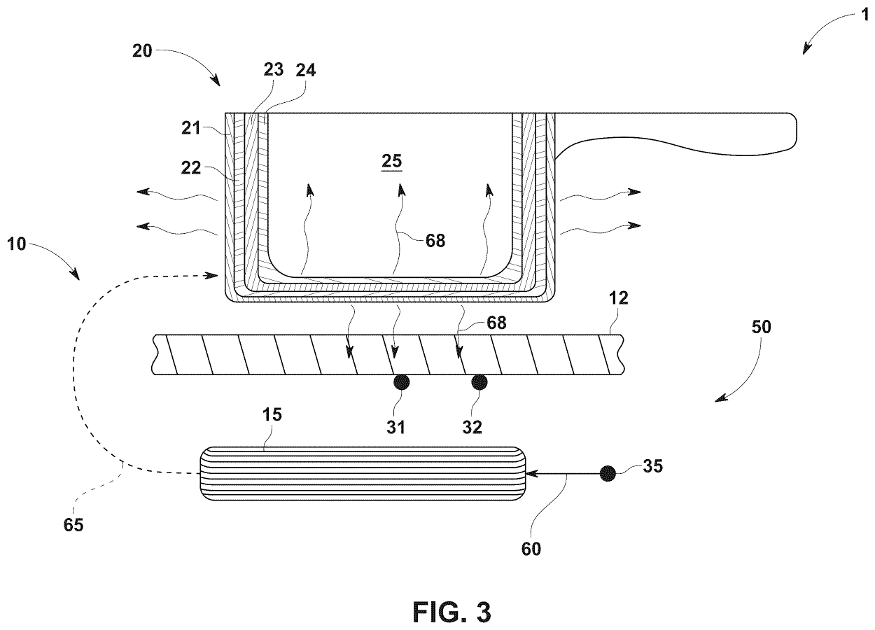

FIG. 3 illustrates some exemplary energy transfers between portions of the cooking appliance 10 and the cooking vessel 20 during operation. The cooking vessel 20, the cook surface 12, and the induction coil 15 are illustrated with exaggerated spacing distances for visual clarity.

A coil power, shown with an arrow 60, represents the electric power delivered to the induction coil 15 by the power supply 52 (FIG. 2). A dashed arrow 65 represents inductive heat produced in the cooking vessel 20 by way of a time-varying electromagnetic field produced by the induction coil 15. Wavy arrows 68 represent vessel heat that is transferred from the cooking vessel 20 to the surrounding environment. For instance, portions of the vessel heat can be conductively transferred to food items within the cooking cavity 25, conductively transferred to the cook surface 12, and/or convectively or radiatively transferred to the surrounding air, in non-limiting examples. In this manner, the cooking vessel 20 can be directly heated by induction via the induction coil 15, and the cook surface 12 can be indirectly heated by way of conduction from the cooking vessel 20, resulting in lower temperatures of the cook surface 12 compared to traditional cooktops.

The energy transfers shown in FIG. 3 are exemplary, and that other energy transfers may also be present between components of the cooking appliance 10 or the cooking vessel 20. For instance, the induction coil 15 can undergo Joule heating during operation, which can lead to additional warming of the cook surface 12, or of ambient air below the cook surface 12, in non-limiting examples.

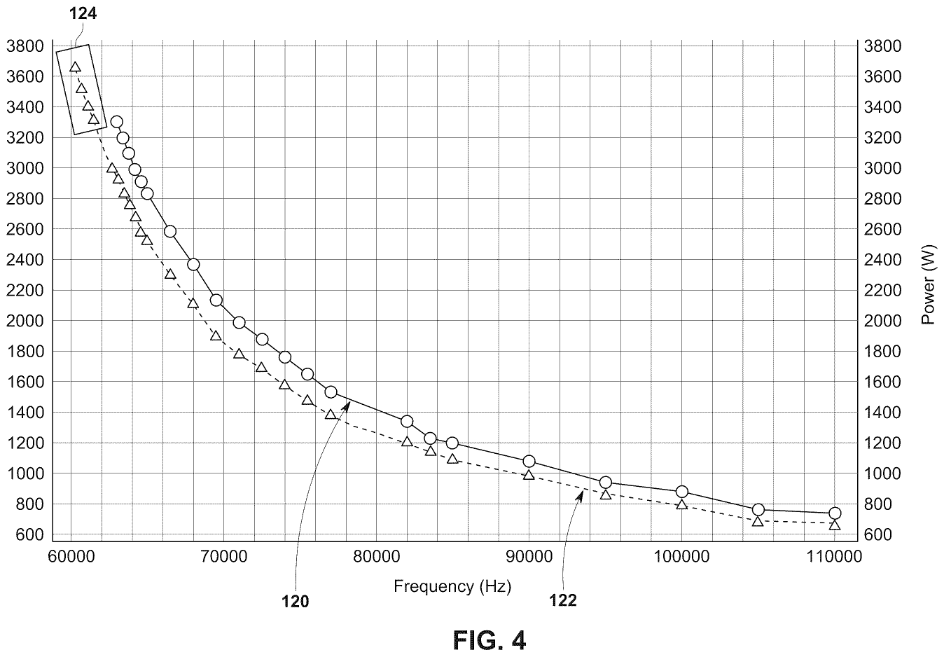

Referring now to FIG. 4, an initial power-frequency curve 120 and an updated power-frequency curve 122 are illustrated. The power-frequency curves 120, 122 illustrate the relationship between the frequency of the electrical power output by the power supply 52 (FIG. 2) to the electrical power at the induction coil 15 (FIG. 2) at an initial time (e.g., at the start of a cycle) and at a subsequent time (e.g., after a change in the system, such as heating of the cooking vessel 20, movement of the cooking vessel 20 by a user, deformation of the bottom surface of the cooking vessel 20, among others), respectively. The power-frequency curves 120, 122 are illustrated in the inductive region above the resonant frequency of the induction cooking system 1. As illustrated, lower frequencies correspond to greater electrical power at the induction coil 15, and higher frequencies correspond to lower electrical power at the induction coil 15. The initial power-frequency curve 120 can be obtained, for example, at the start of a cooking cycle, such as by iteratively adjusting the frequency of the power supply 52 (e.g., via a sweep operation) and/or by obtaining a stored power-frequency curve, such as from the memory 104 of the controller 100 (FIG. 2). The controller 100 can operate the power supply 52 in a first mode to adjust the electrical power at the induction coil 15 toward a target power level, which can include adjusting the electrical power at the induction coil 15 at the target power level.

As the temperatures and/or other parameters of various components of the induction cooking system 1 change, the electrical power at the induction coil 15 and the effective heating power delivered to the cooking vessel 20 also changes. For example, increased temperatures can result in decreased power at the induction coil 15 for a particular frequency, resulting in lower effective heating power delivered to the cooking vessel 20. Continuing to utilize the initial power-frequency curve 120 after such changes can result in delivering less than the target power to the induction coil 15 and less than the desired amount of heating power to the cooking vessel 20, which can result in longer and/or inconsistent cooking times.

The controller 100 can alternately operate the power supply 52 in the first mode and a second mode to update the initial power-frequency curve 120 to obtain the updated power-frequency curve 122. Updating the initial power-frequency curve 120 can include temporarily operating the operating the power supply 52 in the second mode by adjusting the frequency of the power supply 52 from a present frequency to a first other frequency along the initial power-frequency curve 120. For example, the controller 100 can adjust the present frequency of the power supply 52 selected for the target power output to the first other frequency (e.g., a different frequency along the initial power-frequency curve 120) for an update period. During the update period, the controller 100 can obtain an updated power level measurement, such as from the power sensor 35 (FIG. 2), to determine the electrical power at the induction coil 15 at the first other frequency. The controller 100 can then utilize the measured updated power level for the first other frequency as at least a part of the updated power-frequency curve 122. The updated power level can be lower, such as if temperatures have increased since the initial power-frequency curve 120 was obtained, or higher, such as if temperatures have decreased since the initial power-frequency curve 120 was obtained. Increases in temperatures may be encountered more commonly, and will be discussed in more detail herein, but the controller 100 can also update the initial power-frequency curve 120 to compensate for decreases in temperature or other factors increasing the effective delivered power for a given frequency.

The controller 100 can return to operating the power supply 52 in the first mode after obtaining the updated power level. Returning to operating the power supply 52 in the first mode can include operating the power supply 52 to adjust the power output toward the target power level, which can include returning the frequency of the power supply 52 to the present frequency or adjusting the frequency to a different frequency along the initial-power frequency curve 120 updated with the updated power level (e.g., a partially updated version of the updated power-frequency curve 122). For example, the power level at the different frequency can be closer to the target power level than the power level at the present frequency (e.g., if the target power level and/or another parameter has changed). Operating the power supply 52 in the first mode can adjust the power output at the induction coil 15 toward the target power level (e.g., according to the initial power-frequency curve 120 or the partially updated power-frequency curve 122), but may be less than the target power level, such as if the power level has not been updated. For example, operating the power supply 52 in the first mode can include attempting to deliver the target power level to the induction coil 15, but delivering less than the target power level to the induction coil 15 until the corresponding power level has been updated in the updated power-frequency curve 122, or a partially updated version thereof. Based on the non-limiting examples of the power-frequency curves 120, 122 in FIG. 4, with a target power level of 2000 W, the controller 100 operating the power supply 52 in the first mode could control the plurality of switches 56 (FIG. 2) according to the initial power-frequency curve 120 (or a partially updated version of the updated power-frequency curve 122 that has not been updated at 2000 W) at 71,000 Hz, which would actually result in 1800 W of power at the induction coil 152, so less than the target power level would be delivered. Once the update for 2000 W is complete, the resulting frequency is closer to 69,000 Hz, and the controller 100 can operate the power supply 52 in the first mode at 69,000 Hz to deliver 2000 W (or within a small threshold thereof).

The update period, during which the controller 100 operates the power supply 52 in the second mode (e.g., at the different frequency), can be relatively short, which can limit the effect on the cooking cycle. For example, and without limitation, the update period can be at least 5 ms and less than or equal to 15 ms, such as at 8 ms and less than or equal to 10 ms. The controller 100 can then operate the power supply 52 in the first mode for a hold period before operating the power supply 52 in the second mode again (e.g., at a second other frequency along the initial power-frequency curve 120) to obtain a second updated power level to add to the updated power-frequency curve 122. In some examples, the controller 100 can operate the power supply 52 in the second mode to obtain two or more updated power levels before returning to the first mode. For example, the controller 100 can operate the power supply 52 in the first mode to obtain the first updated power level at the first other frequency and the second updated power level at the second other frequency, and return to operating in the first mode for the hold period before operating in the second mode again to obtain a third updated power level at a third other frequency and a fourth update power level at a fourth updated frequency.

The controller 100 can repeat this process of alternating between the first and second modes, which can include temporarily adjusting the frequency of the power supply 52 to a plurality of other frequencies along the initial power-frequency curve 120 to obtain the corresponding updated power levels, to generate the updated power-frequency curve 122. The controller 100 can operate the power supply 52 in the first mode for the hold period between operating at each other frequency in the second mode, which can limit the effects on the cooking cycle. The hold period can be longer than the update period and can, for example and without limitation, be at least 100 ms and less than or equal to 1 second, such as to limit (e.g., counter) the effects of operating in the second mode for the update period. In some examples, the update period can be long enough to allow for updating two or more frequencies before returning to operating in the first mode.

The controller 100 can conduct the update process (e.g., alternating between the first and second modes) to generate updated power-frequency curves (e.g., the updated power-frequency curve 122) periodically, such as with an enable period, and/or can conduct the process upon certain conditions being met, such as sensed changes in temperature via the temperature sensors 31, 32, differences between expected power and the power measured by the power sensor 35, receiving user input, and/or other conditions. The enable period can be significantly longer than the update period. For example, and without limitation, the enable period can be at least 10 seconds and less than or equal to one minute. The controller 100 can generate a new updated power-frequency curve for each iteration of the update process. With some examples, the controller 100 can stop generating updated power-frequency curves (e.g., operate in the first mode and not the second mode) when certain conditions are met, such as if one or more temperatures (e.g., at the cook surface 12) meet or exceed a threshold temperature. The threshold temperature can correspond to a temperature at which the difference between a power level in the present updated power-frequency curve and a measured power level is likely to be immaterial.

In some instances, the target power level can exceed the maximum power level of the updated power-frequency curve 122, including partially updated versions thereof. For example, the maximum power level of the updated power-frequency curve 122 (e.g., the power level at the minimum frequency), at least initially, can be lower than the maximum power level of the initial power-frequency curve 120. The controller 100 can be configured to determine if the target power level exceeds the maximum power level of the updated power-frequency curve 122 and to extend the updated power-frequency curve 122 to allow for higher power levels if the target power level exceeds the maximum power level. The controller 100 can, for example, automatically (e.g., without user input) make the determination of whether the target power level exceeds the maximum power level after generating the updated power-frequency curve 122 or after generating each updated power-frequency curve 122 if more than one is generated, and attempt to extend the updated power-frequency curve 122 if the target power level exceeds the maximum power level.

Extending the updated power-frequency curve 122 can include the controller 100 at least temporarily decreasing the frequency of the power supply 52 below the minimum frequency of the updated power-frequency curve 122 to a first extended frequency. For example, the controller 100 can reduce the frequency of the power supply 52 by a frequency step. The frequency step can be less than a difference between the minimum frequency and the next lowest frequency of the updated power-frequency curve 122. Utilizing a smaller frequency step may be desirable because the power levels associated with lower frequencies can correspond to frequencies, power levels, and/or other parameters that are closer to maximum or minimum thresholds (e.g., maximum power thresholds, maximum current thresholds, maximum temperatures thresholds, the resonant frequency etc.). Extending the updated power-frequency curve 122 can be referred to as operating the power supply 52 in a third mode. In some instances, the controller 100 can operate the power supply 52 in the third mode with the updated power-frequency curve 122 partially updated (e.g., before the updated power-frequency curve 122 is fully updated via alternately operating the power supply 52 in the first and second modes). For example, extending the updated power-frequency curve 122 can include pausing alternately operating the power supply 52 in the first and second modes (e.g., pausing updating).

While operating the power supply 52 at the first extended frequency, the controller 100 can monitor one or more parameters of the induction cooking system 1 to confirm that the one or more parameters are within acceptable ranges. The one or more parameters can, for example, include the electrical current of the induction coil 15. If the one or more parameters are within the acceptable ranges, the controller 100 can obtain a first extended power level (e.g., via the power sensor 35), and add the first extended power level to the updated power-frequency curve 122 at the first extended frequency, which extends the updated power-frequency curve 122. If the one or more parameters are not within the acceptable ranges, the controller 100 can revert to the minimum frequency of the updated power-frequency curve 122. In some examples, after determining that the one or more parameters are not within the acceptable ranges, the controller 100 can then repeat the process at a different extended frequency closer to the minimum frequency (e.g., with a smaller frequency step). In other examples, after determining that the one or more parameters are not within the acceptable ranges, the controller 100 can limit operation to the minimum frequency and/or generate a notification (e.g., a warning light, a warning noise, a text warning, among others).

In some examples, the controller 100 can determine whether the one or more parameters are within the acceptable ranges at the minimum frequency. If the one or more parameters are not within the acceptable ranges, the controller 100 can remove the minimum frequency from the updated power-frequency curve 122, which can result in a new minimum frequency that is higher than the original minimum frequency. The controller 100 can continue this removal process until a frequency at which the one or more parameters are within the acceptable ranges is reached. In some examples, the controller 100 can conduct the removal process while not otherwise updating or extending the updated power-frequency curve 122.

If the one or more parameters are within the acceptable ranges, the controller 100 can repeat the process at one or more other extended frequencies above the first extended frequency to extend the updated power-frequency curve 122 until the target power level is reached or the one or more parameters are not within the acceptable ranges. In FIG. 4, four extended frequencies with corresponding extended power levels are illustrated in the box labeled 124, each corresponding to a successively lower frequency and higher power level. The extended frequencies are lower than the minimum frequency of the initial power-frequency curve 120. The extended power levels corresponding to the extended frequencies are higher than the maximum power level of the updated power-frequency curve 122. The extended power levels can be less than, equal to, and/or greater than the maximum power level of the initial power-frequency curve 120.

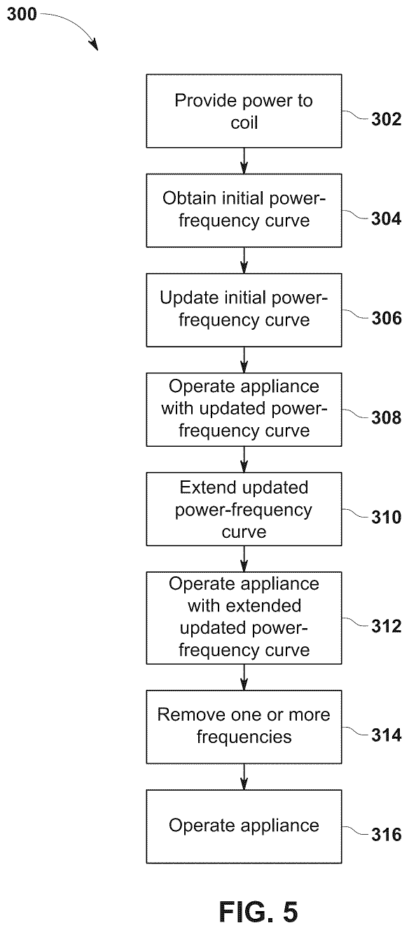

Referring now to FIG. 5, a method 300 is illustrated for controlling the induction cooking system 1 and components thereof illustrated in FIGS. 1-4, such as the cooking appliance 10. The method 300 includes providing power from the power supply 52 to the induction coil 15 (block 302), which can include the controller 100 operating the power supply 52 in the first mode, which can include the controller 100 controlling the set of switches 56 at the present frequency and/or one or more other frequencies to adjust the power at the induction coil 15 toward the target power level for the cooking vessel 20, such as according to the initial power-frequency curve 120. The method 300 includes obtaining the initial power-frequency curve 120 (block 304). The controller 100 can obtain the initial power-frequency curve 120 as a stored power-frequency curve from the memory 104 and/or can generate the initial power-frequency curve 120, such as by (i) obtaining the power level at the present frequency and (ii) adjusting the frequency of the power supply 52 to the plurality of the frequencies (e.g., in the inductive region of the induction cooking system 1) and obtaining the corresponding power levels, such as via the power sensor 35. In some examples, block 304 is conducted prior to and/or simultaneously with block 302.

The method 300 can include updating the initial power-frequency curve 120 to obtain the updated power-frequency curve 122 (block 306). Updating the initial power-frequency curve in block 306 can include alternating between operating the power supply 52 in the first and second modes, which can include temporarily adjusting the frequency of the power supply 52 from the present frequency to the plurality of other frequencies along the initial power-frequency curve, obtaining updated power levels at the plurality of other frequencies, and adjusting the frequency of the power supply back to the present frequency or another frequency to adjust the power at the induction coil toward the target power level after obtaining each updated power level or a set of power levels. The updated power levels can be lower than the corresponding power levels of the initial power-frequency curve 120. Temporarily adjusting the frequency to the plurality of other frequencies can include adjusting the frequency to each of the plurality of other frequencies for the update period, which can, for example, be at least 5 ms and less than or equal to 15 ms, or at least 8 ms and less than or equal to 10 ms.

The method 300 can include operating the cooking appliance 10 according to the updated power-frequency curve 122 (block 308). For example, in response to the receiving the target power level, the controller 100 can operate the power supply 52 in the first mode according to the updated power-frequency curve 122 to heat the cooking vessel 20.

The method 300 can include extending the updated power-frequency curve 122 (block 310). Extending the updated power-frequency curve 122 in block 310 can include adding a first extended power level at a first extended frequency. For example, the controller 100 can adjust the frequency of the power supply 52 to the first extended frequency, below the minimum frequency of the updated power-frequency curve 122, monitor the one or more parameters, and add the first extended power level, obtained via the power sensor 35, for example, to the updated power-frequency curve 122 if the one or more parameters are within acceptable ranges. If the one or more parameters are within the acceptable ranges, the controller 100 can continue to operate the power supply 52 at the first extended frequency to provide the first extended power level. The first extended power level can be higher than a maximum power level of the updated power-frequency curve 122 and/or a maximum power level of the initial power-frequency curve 120. The first extended frequency can be lower than a minimum frequency of the initial power-frequency curve 120 and/or lower than a minimum frequency of the updated power-frequency curve 122.

In some examples, extending the updated power-frequency curve 122 in block 310 can include adding a plurality of extended power levels at a plurality of extended frequencies, such as if the one or more parameters remain with the acceptable ranges as the controller 100 decreases the frequency of the power supply 52 from the minimum frequency of the updated power-frequency curve 122 to the plurality of extended frequencies, including the first extended frequency. The plurality of extended power levels can be higher than a maximum power level of the updated power-frequency curve 122. The plurality of extended frequencies can be lower than a minimum frequency of the initial power-frequency curve 120.

The method 300 can include operating the cooking appliance 10 according to the extended updated power-frequency curve 122 (block 312). For example, in response to the target power exceeding the maximum power of updated power-frequency curve 122, prior to extension, the controller 100 can operate the power supply 52 at the first extended frequency or another extended frequency added in block 310.

The method 300 can include removing one or more frequencies from the updated power-frequency curve 122 (block 314), which can include the extended power-frequency curve 122. For example, the controller 100 can monitor one or more parameters of the cooking appliance 10 while operating the power supply 52 at various frequencies, such as a minimum frequency, and remove one or frequencies from the updated power-frequency curve 122 at which the one or more parameters are not within acceptable ranges. Removing the minimum frequency can result in a new minimum frequency (e.g., the second lowest frequency of the updated power-frequency curve 122).

The method 300 can include operating the cooking appliance 10 according to the updated power-frequency curve after removing one or more frequencies in block 314 (block 316).

While block 310 is illustrated in FIG. 5 after block 306, block 310 can be conducted prior to the completion of block 306, and/or blocks 306 and 310 can start at substantially the same time. For example, the controller 100 can pause the updating in block 306 to operate in the third mode to extend the partially updated power-frequency curve in block 310, and then continue the updating in block 306 after extending is complete.

While block 314 is illustrated in FIG. 5 after blocks 306 and 310, block 314 can be included with block 306 and can be conducted prior to or after blocks 306 and 310.

The term “power-frequency curve” does not require an actual curve or one or more lines connecting points. For example, a power-frequency curve can be provided via a plot of power levels at corresponding frequencies as points without interconnecting lines, and/or can be provided as a table (e.g., a look-up table).

Further aspects of the disclosure are provided by the subject matter of the following clauses:

A method of controlling an induction cooking appliance having a cook surface and an induction coil electrically connected with a power supply, and with a cooking vessel disposed on the cook surface, the method comprising: obtaining a target power level for a cooking cycle; obtaining an initial power-frequency curve including a plurality of power levels at a plurality of frequencies; and alternating between operating the power supply in a first mode and a second mode to iteratively update the plurality of power levels and obtain an updated power-frequency curve; wherein operating the power supply in the first mode includes operating the power supply to adjust a power output of the induction coil toward the target power level; and operating the power supply in the second mode includes operating the power supply to update at least one power level of the plurality of power levels.

The method of any preceding clause, wherein alternating between the first mode and the second mode includes operating the power supply in the first mode for a hold period and operating in the second mode for an update period that is shorter than the hold period.

The method of any preceding clause, wherein the at least one power level includes a single power level at one frequency of the plurality of frequencies.

The method of any preceding clause, wherein the at least one power level includes two or more power levels at two or more corresponding frequencies of the plurality of frequencies.

The method of any preceding clause, wherein the update period is at least 5 ms and less than or equal to 15 ms.

The method of any preceding clause, wherein the update period is at least 8 ms and less than or equal to 10 ms.

The method of any preceding clause, wherein operating the power supply to adjust the power output toward the target power level includes operating the power supply at a target frequency of the plurality of frequencies that corresponds to the target power level.

The method of any preceding clause, wherein the power output at the target frequency is less than the target power level.

The method of any preceding clause, wherein the updated at least one power level is lower than a corresponding power level of the initial power-frequency curve.

The method of any preceding clause, wherein obtaining the initial power-frequency curve includes obtaining the plurality of power levels at the plurality of frequencies.

The method of any preceding clause, wherein obtaining the initial power-frequency curve includes accessing a stored power-frequency curve stored in a memory of a controller of the induction cooking appliance.

The method of any preceding clause, further comprising operating the induction cooking appliance according to the updated power-frequency curve.

The method of any preceding clause, further comprising extending the updated power-frequency curve.

The method of any preceding clause, wherein extending the updated power-frequency curve includes adding a first extended power level at a first extended frequency.

The method of any preceding clause, wherein the first extended power level is higher than a maximum power level of the updated power-frequency curve.

The method of any preceding clause, wherein the first extended frequency is lower than a minimum frequency of the initial power-frequency curve.

The method of any preceding clause, wherein extending the updated power-frequency curve includes adding a plurality of extended power levels at a plurality of extended frequencies; the plurality of extended power levels are higher than a maximum power level of the initial power-frequency curve; and the plurality of extended frequencies are lower than a minimum frequency of the initial power-frequency curve.

The method of any preceding clause, wherein extending the updated power-frequency curve includes adding a plurality of extended power levels at a plurality of extended frequencies; the plurality of extended power levels are higher than a maximum power level of the updated power-frequency curve; and the plurality of extended frequencies are lower than a minimum frequency of the updated power-frequency curve.

The method of any preceding clause, wherein the updated power-frequency curve is partially updated, and extending the updated power-frequency curve includes operating the power supply in a third mode and pausing the alternating between operating the power supply in the first mode and the second mode.

The method of any preceding clause, wherein extending the updated power-frequency curve includes: monitoring a parameter of the induction cooking appliance while providing operating the power supply to provide power at a first extended frequency; and adding a first extended power level at the first extended frequency if the parameter is within an acceptable range.

The method of any preceding clause, further comprising monitoring a parameter of the induction cooking appliance while operating the power supply to provide power at a minimum frequency, and removing the minimum frequency in accordance with determining that the parameter is not within acceptable ranges.

The method of any preceding clause, further comprising operating the induction cooking appliance according to the extended updated power-frequency curve.

The method of any preceding clause, wherein an extended frequency step between the plurality of extended frequencies is less than a difference between the minimum frequency and a next lowest frequency of the initial power-frequency curve.

An electronic controller configured to conduct the method of any preceding clause.

An induction cooking appliance, comprising: a cook surface; an induction coil disposed adjacent the cook surface; a power supply electrically connected to the induction coil; and a controller electrically connected to the power supply, the controller configured to conduct the method of any preceding clause.

An induction cooking appliance, comprising: a cook surface; an induction coil disposed adjacent the cook surface; a power supply electrically connected to the induction coil; and a controller electrically connected to the power supply, the controller configured to: control operation of the power supply to provide power from the power supply to the induction coil; obtain an initial power-frequency curve; and alternately operate the power supply in a first mode and a second mode to iteratively update a plurality of power levels of the initial power-frequency curve and obtain an updated power-frequency curve.

The induction cooking appliance of any preceding clause, wherein the controller is configured to extend the updated power-frequency curve.

The induction cooking appliance of any preceding clause, wherein extending the updated power-frequency curve includes adding one or more extended power levels at one or more extended frequencies below a minimum frequency of the updated power-frequency curve.

The induction cooking appliance of any preceding clause, wherein operating the power supply in the first mode includes operating the power supply to adjust a power output toward the target power level; and operating the power supply in the second mode includes operating the power supply to update at least one power level of the plurality of power levels of the initial power-frequency curve.

The induction cooking appliance of any preceding clause, wherein the controller is configured to conduct the method of any preceding clause.

A non-transitory computer-readable storage medium having a computer program encoded thereon for implementing the method of any preceding embodiment.

Aspects of the present disclosure described herein provide for an induction cooking appliance and method with an improved temperature estimation performance compared to traditional induction cooktops. Aspects of the disclosure further provide for controllable temperature operation having broad compatibility with available cooking vessels, pans, griddles, and the like, without need of individual calibration or external temperature probes.

To the extent not already described, the different features and structures of the various aspects can be used in combination with each other as desired. That one feature is not illustrated in all of the aspects is not meant to be construed that it cannot be, but is done for brevity of description. Thus, the various features of the different aspects can be mixed and matched as desired to form new aspects, whether or not the new aspects are expressly described.

This written description uses examples to disclose aspects of the disclosure, including the best mode, and also to enable any person skilled in the art to practice aspects of the disclosure, including making and using any devices or systems and performing any incorporated methods. While aspects of the disclosure have been specifically described in connection with certain specific details thereof, it is to be understood that this is by way of illustration and not of limitation. Reasonable variation and modification are possible within the scope of the forgoing disclosure and drawings without departing from the spirit of the disclosure, which is defined in the appended claims.

What is claimed is:

1. A method of controlling an induction cooking appliance having a cook surface and an induction coil electrically connected with a power supply, and with a cooking vessel disposed on the cook surface, the method comprising:
obtaining a target power level for a cooking cycle;
obtaining an initial power-frequency curve including a plurality of power levels at a plurality of frequencies; and
alternating between operating the power supply in a first mode and a second mode to iteratively update the plurality of power levels and obtain an updated power-frequency curve;
wherein operating the power supply in the first mode includes operating the power supply to adjust a power output of the induction coil toward the target power level; and
operating the power supply in the second mode includes operating the power supply to update at least one power level of the plurality of power levels.

2. The method of claim 1, wherein alternating between the first mode and the second mode includes operating the power supply in the first mode for a hold period and operating in the second mode for an update period that is shorter than the hold period.

3. The method of claim 2, wherein the at least one power level includes a single power level at one frequency of the plurality of frequencies.

4. The method of claim 1, wherein the at least one power level includes two or more power levels at two or more corresponding frequencies of the plurality of frequencies.

5. The method of claim 4, wherein the update period is at least 5 ms and less than or equal to 15 ms.

6. The method of claim 4, wherein the update period is at least 8 ms and less than or equal to 10 ms.

7. The method of claim 1, wherein operating the power supply to adjust the power output toward the target power level includes operating the power supply at a target frequency of the plurality of frequencies that corresponds to the target power level.

8. The method of claim 7, wherein the power output at the target frequency is less than the target power level.

9. The method of claim 1, wherein the updated at least one power level is lower than a corresponding power level of the initial power-frequency curve.

10. The method of claim 1, wherein obtaining the initial power-frequency curve includes obtaining the plurality of power levels at the plurality of frequencies.

11. The method of claim 1, wherein obtaining the initial power-frequency curve includes accessing a stored power-frequency curve stored in a memory of a controller of the induction cooking appliance.

12. The method of claim 1, further comprising operating the induction cooking appliance according to the updated power-frequency curve.

13. The method of claim 1, further comprising extending the updated power-frequency curve.

14. The method of claim 13, wherein extending the updated power-frequency curve includes adding a first extended power level at a first extended frequency.

15. The method of claim 14, wherein the first extended power level is higher than a maximum power level of the updated power-frequency curve.

16. The method of claim 15, wherein the first extended frequency is lower than a minimum frequency of the initial power-frequency curve.

17. The method of claim 13, wherein extending the updated power-frequency curve includes adding a plurality of extended power levels at a plurality of extended frequencies;
the plurality of extended power levels are higher than a maximum power level of the initial power-frequency curve; and
the plurality of extended frequencies are lower than a minimum frequency of the initial power-frequency curve.

18. The method of claim 13, wherein the updated power-frequency curve is partially updated, and extending the updated power-frequency curve includes operating the power supply in a third mode and pausing the alternating between operating the power supply in the first mode and the second mode.

19. The method of claim 13, wherein extending the updated power-frequency curve includes:
monitoring a parameter of the induction cooking appliance while providing operating the power supply to provide power at a first extended frequency; and
adding a first extended power level at the first extended frequency if the parameter is within an acceptable range.

20. The method of claim 13, further comprising operating the induction cooking appliance according to the extended updated power-frequency curve.
